(19) United States
(12) Patent Application Publication
(10) Pub. No.: US 2022/0180028 A1
(43) Pub. Date: Jun. 9, 2022

(54) DOWNHOLE ELECTRODE PLACEMENT OPTIMIZATION

(71) Applicants: Chevron U.S.A. Inc., San Ramon, CA (US); Triad National Security, LLC, Los Alamos, NM (US)

(72) Inventors: Maruti Kumar Mudunuru, Los Alamos, NM (US); Vamshi Krishna Chillara, Los Alamos, NM (US); Bulbul Ahmmed, Los Alamos, NM (US); Satish Karra, Los Alamos, NM (US); Hari Selvi Viswanathan, Los Alamos, NM (US); Jeffrey Foering App, Houston, TX (US); Gary Michael Hoversten, Lafayette, CA (US); Christopher J. Champeaux, Spring, TX (US); Jesus Barraza, Houston, TX (US)

(21) Appl. No.: 17/116,163

(22) Filed: Dec. 9, 2020

(51) Int. Cl. G06F 30/28; E21B 47/113; E21B 43/16

(52) U.S. Cl. CPC G06F 30/28; E21B 47/113; G06F 2113/08; E21B 2200/20; E21B 43/162

(57) ABSTRACT

A method for determining placement of MFEIT sensors in a horizontal well for detecting producing stages of the horizontal well. Embodiments involve computationally modeling the underlying physics of a well system and performing inversion to identify the MFEIT parameters (locations and conductivity) from electrical impedance measurements.

### STATEMENT REGARDING FEDERAL RIGHTS

The United States government has certain rights in this invention pursuant to Contract No. 89233218CNA000001 between the United States Department of Energy and TRIAD National Security, LLC for the operation of Los Alamos National Laboratory.

### PARTIES TO JOINT RESEARCH AGREEMENT

The research work described here was performed under a Cooperative Research and Development Agreement (CRADA) between Los Alamos National Laboratory (LANL) and Chevron under the LANL-Chevron Alliance, CRADA number LA05C10518.

### TECHNICAL FIELD

The present disclosure relates generally to methods to identify potential locations of electrodes for performing multi-frequency electrical impedance tomography (MFEIT) measurements in order to identify producing zones in horizontal wells. Electrodes can be placed at the identified locations.

### BACKGROUND

Hydrofracturing, commonly known as hydraulic fracturing or fracking, is a method of increasing the flow of oil, gas, or other fluids within a rock formation. Unconventional or tight wells are typically comprised of multiple fracture stages which are completed in series during completion operations. These wells can also be known as horizontal wells, as a portion of the well can be drilled horizontally (parallel the surface). Hydrofracturing involves pumping a fracturing fluid into a wellbore under high pressure such that fractures form in the rock formation surrounding the wellbore, thus, increasing the permeability of the formation and increasing recovery of oil and gas.

As described above, producing oil using fracturing technology involves preservation of the subsurface with a displacing fluid. However, a variety of failures related to the geometry of the subsurface environment may complicate oil production. Well bores may communicate with one another causing a lack of production from the desired borehole, for instance. Also, fracturing fluid can fail to access the desired strata or area of the oil-bearing formation, resulting in a lack of production. Hydrocarbon production from hydraulic fracturing involves extraction from horizontal wells with multiple potential production zones or stages. As seen from the discussion above, different stages within a well can have heterogeneous production due to a variety of issues.

### BRIEF SUMMARY OF EXAMPLE EMBODIMENTS

Various embodiments of the present disclosure may include systems, methods, and non-transitory computer readable media configured to determine placement of MFEIT sensors in a subterranean reservoir. A fluid conductivity, a background conductivity, a current to be injected, and a geological model of the subsurface reservoir may be received. The geological model may comprise a domain size, a plurality of sensor locations, steel infrastructure dimensions, a horizontal well location, steel infrastructure locations, a distance between perforations, and a distance between stages. An injection of the current at a first sensor location may be simulated using the geological model and the background conductivity. A voltage received at a second sensor location may be calculated. The voltage may be outputted.

In some embodiments, the first sensor location where the current is injected, and the second sensor location where the voltage is received may be received.

In some embodiments, sensors may be placed in the subterranean reservoir at the plurality of sensor locations.

In some embodiments, a second plurality of sensor locations may be received. A second current injected at a first sensor location of the second plurality of sensor locations may be simulated. A second voltage received at a second sensor location of the second plurality of sensor locations may be calculated. The voltage received at the second sensor location and the second voltage received at the second sensor location of the second plurality of sensor locations may be compared. A highest voltage as between the voltage received at the second sensor location and the second voltage received at the second sensor location of the second plurality of sensor locations may be outputted.

In some embodiments, sensor locations associated with the highest voltage may be outputted.

In some embodiments, sensors may be placed in the subterranean reservoir at the sensor locations associated with the highest voltage.

In some embodiments, simulating the injection of the current at the first sensor location may include simulating the current being injected at a first electrode and the current being received at a second electrode. Calculating the voltage received at the second sensor location may include measuring simulated voltage between a third electrode and a fourth electrode. The third electrode and the fourth electrode may be between the first electrode and the second electrode.

In some embodiments, the plurality of sensor locations may be outside the horizontal well location.

In some embodiments, the plurality of sensor location may be within the horizontal well location.

In some embodiments, the subterranean reservoir may be an unconventional formation.

### BRIEF DESCRIPTION OF THE DRAWINGS

The drawings illustrate only example embodiments of methods, systems, and devices for compositions and methods for downhole sensor placement optimization and are therefore not to be considered limiting of the scope of the disclosure. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 illustrates an example of electrode placement with MFEIT ring electrodes placed outside the well.

FIG. 2 illustrates an example of electrode placement with MFEIT wire electrode to probe the zones of interest.

FIG. 3 shows graphs of electric potential distribution due to point electrodes and line electrodes of different length at 1.5 kHz: FIG. 3a is a point sensor, FIG. 3b is a 10 m line sensor, FIG. 3c is a 100 m line sensor, and FIG. 3d is a 500 m line sensor. Computational analysis was performed for different line sensor lengths.

FIG. 4 is a graph of normalized electric potential distribution as a function of depth for point and line sensors at x=0.

FIG. 5 is a graph illustrating the effect of line sensor depth and frequency-dependent response. The curves from top to bottom are, respectively, 5 cm, 10 cm, 15 cm, and 20 cm line sensor depth.

FIG. 6 illustrates the voltage decay with distance for line sensors for a depth of 20 cm. FIG. 6a illustrates the voltage measured between each of the other electrodes and the ground. FIG. 6b illustrates linear voltage decay with distance for low-frequency.

FIG. 7 is a graph that shows frequency-dependence of voltage in sand. The curves from top to bottom are, respectively, 4 cm, 8 cm, 12 cm, 16 cm, 20 cm, and 24 cm.

FIG. 8 illustrates changes in impedance values with frequencies (FIG. 8a) and time for water-infused sand based on a three electrode configuration (FIG. 8b).

FIG. 9 is a graph of frequency-dependent electrical impedance characteristics of mineral oil and tap water with different salt concentrations. The curves from top to bottom are, respectively, mineral oil, tap water, tap water+30,000 ppm salt, and tap water+60,000 ppm salt.

FIG. 10a is a graph of electrical impedance curves for different oil-water mixtures with increasing mineral oil concentration. The curves from top to bottom are, respectively, 50%, 43%, 39%, 33%, 27%, 20%, 11%, and 0%. FIG. 10b is a graph that shows electrical impedance at 10 kHz for varying oil concentration in an oil-water mixture.

FIG. 11 is a schematic of the four-electrode configuration used for experiments.

FIG. 12 is a graph of linear chirp signals used for four-electrode measurements.

FIG. 13 is a graph of output measurements for different water cuts of mineral oil to salt water mixtures.

FIGS. 14a, 14b, and 14c are graphs of results with low-frequency excitation (10 Hz) for different oil-cuts (a) 80% (b) 58% (c) 50%.

FIG. 15 is a graph of results with low-frequency excitation for different mineral oil-cuts.

FIG. 16 is a model used in modeling studies that account for steel pipe infrastructure and different inflow fluid conductivities.

FIG. 17 shows the simulated stage impedance for different inflow fluid conductivities.

FIG. 18 is a model domain used to compare experiments and numerical modeling results.

FIG. 19 is a numerical modeling result using fine mesh which consists of 20 million cells.

FIG. 20 is a comparison of experimental and modeling results at different frequencies. FIG. 20a is for 1 kHz, FIG. 20b is for 5 kHz, and FIG. 20c is for 10 kHz. The experimental numbers are the upper curves on each polt and the modeling numbers are the lower curves on each plot.

FIG. 21 is a reservoir-scale model with coarse mesh. The model has dimensions of 3,500×1,500×3,500 m³.

FIG. 22 is a reservoir-scale model with finer mesh. The model has dimensions of 3,500×1,500×3,500 m3.

FIG. 23 is a model representation of a zone of interest where fracking is performed.

FIG. 24 is the model representation of FIG. 23 illustrating the position of wells (center lines).

FIG. 25 illustrates the electrode configuration used for simulations.

FIG. 26 is a graph of the simulated real component of the complex electrical field.

FIG. 27 is a graph of the simulated imaginary component of the complex electrical field.

FIG. 28 is an illustration of electrode/sensor placement schematic inside the well.

FIG. 29 is an illustration of electrode/sensor placement schematic on a tailpipe below a packer.

### DETAILED DESCRIPTION OF EXAMPLE EMBODIMENTS

Hydrocarbon production from hydraulic fracturing involves extraction from horizontal wells with multiple potential production zones or stages. While the overall hydrocarbon sweep efficiency is dictated by the producing zones, it is a challenging task to identify the individual producing stages. There is a strong need for a reliable technique to identify the producing zones along the entire horizontal well as it can result in reduction of operational and production costs. Techniques such as acoustic emission monitoring from hydrocarbon flow processes provide localized assessment of hydrocarbon flow but cannot be used to monitor the entire horizontal well that can run for greater than 10,000 feet in length. On the other hand, geoelectrical methods such as Electrical Resistivity Tomography (ERT) and Electrical Impedance Tomography (EIT) are global and are particularly attractive for monitoring large areas.

Existing geoelectrical sensing techniques are primarily based on ERT and utilize point sensors to obtain bulk subsurface electrical resistivity maps. Use of point sources results in less subsurface volumetric coverage due to smaller electric field penetration depth. Moreover, as ERT is based on direct current, it results in high resistive power losses. For these reasons, existing technology cannot efficiently be employed to monitor flowing stages in a horizontal well that requires large-scale subsurface interrogation.

“Hydrocarbon-bearing formation,” “conventional formation,” or simply “formation” refers to the rock matrix in which a wellbore may be drilled. For example, a formation refers to a body of rock that is sufficiently distinctive and continuous such that it can be mapped. It should be appreciated that, while the term “formation” generally refers to geologic formations of interest, the term “formation,” as used herein, may, in some instances, include any geologic points or volumes of interest (such as a survey area).

“Unconventional formation” is a hydrocarbon-bearing formation that requires intervention in order to recover hydrocarbons from the reservoir at commercial flow rates. For example, an unconventional formation includes reservoirs having an unconventional microstructure, such as having submicron pore size, in which the unconventional reservoir must be fractured under pressure in order to recover hydrocarbons from the reservoir at sufficient flow rates.

The formation, either conventional or unconventional, may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc. Furthermore, the formation may include hydrocarbons, such as liquid hydrocarbons (also known as oil or petroleum), gas hydrocarbons, a combination of liquid hydrocarbons and gas hydrocarbons, etc.

The formation, the hydrocarbons, or both may also include non-hydrocarbon items, such as pore space, connate water, brine, fluids from enhanced oil recovery, etc. The formation may also be divided up into one or more hydrocarbon zones, and hydrocarbons can be produced from each desired hydrocarbon zone.

The term formation may be used synonymously with the term reservoir. For example, in some embodiments, the reservoir may be, but is not limited to, a shale reservoir, a carbonate reservoir, etc. Indeed, the terms “formation,” “reservoir,” “hydrocarbon,” and the like are not limited to any description or configuration described herein.

“Wellbore” refers to a single hole for use in hydrocarbon recovery, including any openhole or uncased portion of the wellbore. For example, a wellbore may be a cylindrical hole drilled into the formation such that the wellbore is surrounded by the formation, including rocks, sands, sediments, etc. A wellbore may be used for injection. A wellbore may be used for production. A wellbore may be used for hydraulic fracturing. A wellbore even may be used for multiple purposes, such as injection and production. The wellbore may have vertical, inclined, horizontal, or combination trajectories. For example, the wellbore may be a vertical wellbore, a horizontal wellbore, a multilateral wellbore, or a slanted wellbore. The term wellbore is not limited to any description or configuration described herein. The term wellbore may be used synonymously with the terms borehole or well.

Unless defined otherwise, all technical and scientific terms used herein have the same meanings as commonly understood by one of skill in the art to which the disclosed invention belongs.

An embodiment of the disclosure is a computational methodology to identify potential positions of electrodes within a well system in order to perform multifrequency electrical impedance tomography (MFEIT) measurements with the goal to efficiently detect producing and non-producing stages along the horizontal well in an unconventional reservoir. Embodiments of the disclosure involve computationally modeling the underlying physics of a well system and performing inversion to identify the MFEIT parameters (locations and conductivity) from electrical impedance measurements. Embodiments of the disclosure result in efficient spacing strategies between MFEIT sensors that are needed to cover each stage of a horizontal well while minimizing the number of sensors. Each MFEIT sensor is able to give local information about the stage in which it is positioned. In embodiments, the sensors are placed across stages, which can comprise different perforations and fractures. Embodiments of the MFEIT sensing technology can use multiple frequencies. Embodiments of the disclosure are cost-effective solutions (e.g., low-cost sensors/electrodes and fast data processing) for efficient detection, distribution, and localization of hydrocarbon producing zones/stages.

Embodiments of the disclosure are drawn to optimizing the placement of MFEIT sensors that are to be placed within a 3D model of a horizontal well. In embodiments, a plurality of different placement options are simulated and the most sensitive placement with the least amount of sensors is chosen. In embodiments, sensors are then placed at the locations determined from the simulation within the horizontal well that was represented by the 3D model.

Embodiments of the disclosure use MFEIT sensors. In certain embodiments, the MFEIT sensors are line sensors. In some embodiments, the line sensors are between 5-50 m long. In some embodiments, the MFEIT sensors are ring sensors. In some embodiments, the MFEIT sensors comprise 4 electrodes. Use of other types of electrical/MFEIT sensors is contemplated.

Embodiments of the disclosure include numerical modeling/simulation. In some embodiments, the numerical modeling/simulation is based on finite element method to solve MFEIT equations. In some embodiments, the numerical modeling/simulation includes solving the entire set of Maxwell equations. In some embodiments, the numerical modeling/simulation includes Finite Difference Time Domain (FDTD) methods and edge finite element methods to compute electric and magnetic fields in the domain. Use of other types of numerical modeling/simulation is contemplated. In some embodiments, the models are run using E4D, Res2Dinv, Aarhusinv, BERT, EarthImager3D, pyGIMLi, pyEIT, EIDORS, and/or ZondRes3D. Use of other types of software programs for numerical modeling/simulation is contemplated. Embodiments of the disclosure use numerical modeling/simulation to compute conductivity and voltage.

In embodiments of the disclosure, inputs are received to be used by the numerical modeling software. In certain embodiments, the inputs include length of the well, placement of perforation spacing, height of well, steel infrastructure (steel conductivity), background conductivity, fluid conductivity, amount of perforations, length of perforations, size of perforations, sensor placement, distance between sensors, source electrode, receiver electrode, amount of current injected, type of output measurement, amount of mesh refinement in each area within the model (i.e. higher inside, lower outside), number of processors, number of electrodes, type of electrode, distance between perforation clusters, perforation hole count, perforation hole size and orientation, quantities of sand and water pumped during fracturing operation, and/or distance between stages. Embodiments of the disclosure require the following input: domain size, sensor placement, steel infrastructure dimensions, distance between perforations, fluid conductivities, background conductivities, amount of current injected, distance between perforation clusters, perforation hole count, perforation hole size and orientation, quantities of sand and water pumped during fracturing operation, and/or distance between stages. Use of other input is contemplated. In embodiments of the disclosure, the output of the simulation is the potential difference between two electrodes, the sensitivity of different electrode placement modalities, minimum number of sensors required to discern inflow change, and/or a specific electrode placement modality. The output data can be output such that a user has access to the data. For example, the output data can be output on a computer monitor, a computer readable medium, or a printer. Computer readable medium includes hard drives, solid state drives, flash drives, memory, CD, DVD, or any computer readable medium that is non-transitory.

Embodiments of the disclosure include receiving inputs from an external source, such as a database or an internet connection. In embodiments, 3D models are developed from geological surveys of a formation. The 3D model represents the formation in such a way that a simulation performed on the 3D model is a close approximation to what would happen within the physical formation.

“About,” as used herein, generally refers to a range of numbers that one of ordinary skill in the art would consider as a reasonable amount of deviation to the recited numeric values (i.e., having the equivalent function or result). For example, this term “about” can be construed as including a deviation of ±10 percent of the given numeric value, provided such a deviation does not alter the end function or result of the value.

Example embodiments will be described more fully hereinafter, in which example methods for determining efficient positioning of MFEIT sensors are described. It should be understood that systems, apparatuses, compositions and methods mentioned herein may be embodied in many different forms and should not be construed as limited to the example embodiments set forth herein. Rather, these example embodiments are provided so that this disclosure will be thorough and complete, and will fully convey the scope of the claims to those of ordinary skill in the art. Like, but not necessarily the same, elements in the various figures are denoted by like reference numerals for consistency.

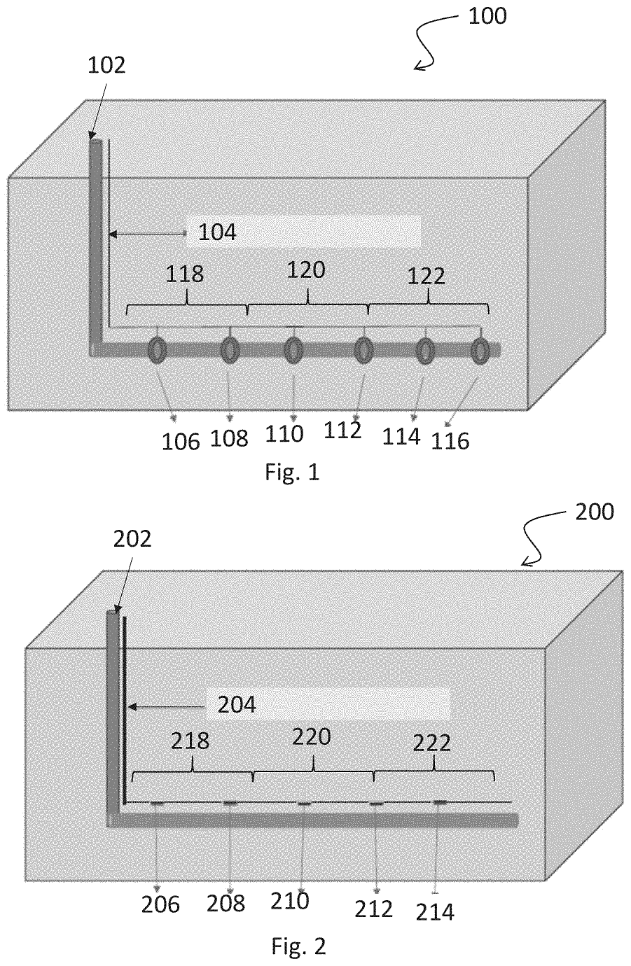

FIGS. 1 and 2 illustrate two non-limiting examples of sensor placement. FIG. 1 illustrates a well system 100 with MFEIT sensors which act as sources and receivers simultaneously. The well system 100 comprises a well 102 and a bundle of wires 104 that run along the well. The bundle of wires 104 connect to MFEIT sensors 106, 108, 110, 112, 114, and 116. MFEIT sensors 106 and 108 are located in zone 118, MFEIT sensors 110 and 112 are located in zone 120 and MFEIT sensors 114 and 116 are located in zone 122. As shown, the MFEIT sensors are placed around a pipe with fiber optic wires connecting the MFEIT sensors 106, 108, 110, 112, 114, and 116 to the other sensors and the surface receiver, such as a computer (not shown). In embodiments, the MFEIT sensors 106, 108, 110, 112, 114, and 116 can act as sources and receivers simultaneously based on multiplexing. As a result, the sensors can probe the subsurface and the zones of interest efficiently.

FIG. 2 illustrates a well system 200 with MFEIT sensors which act as sources and receivers. The well system 100 comprises a well 202 and an enclosed tube of insulated wires 204 that runs alongside the well. In this example, wire electrodes act as sources and receivers which can be operated from the surface. Multiple insulated wires are housed inside the enclosed tube of insulated wires 204. At positions 206, 208, 210, 212, and 214 one of the insulated wires ends such that the wire is exposed to the formation at that particular position. As such, one wire at each position 206, 208, 210, 212, and 214 acts as an electrode while the rest of the wires around the exposed individual wire are insulated. In certain embodiments, the enclosed tube of insulated wires is placed outside the well casing. In other embodiments, the enclosed tube of insulated wires is placed within the well casing. In embodiments, the enclosed tube of insulated wires 204 is positioned along a length of the horizontal well so that it does not interfere with drilling, completion, and production operations. The insulated wires can be excited from the surface using a multiplexer. All the wires of the MFEIT system can be placed in an enclosed tube of insulated wires 204 which can include other bundles of wires and/or fiber optic cables. Information is collected from measured voltages at each section using a multiplexer along with data collected using, for example, fiber optic cables and other types of sensors and the measured voltages and other collected data are sent to a computer at the surface (not shown). In some embodiments, impedance measurements (real and complex potentials) are collected.

In embodiments of the disclosure, the sensors are placed along a horizontal well close to each and every stage in order to measure the amount of gas and oil coming from each and every stage. In embodiments, sensors are placed on the well casing or on production tubing. In embodiments, the sensors are placed inside or outside of the well casing, while in close proximity to the casing (at least within 20 ft. of the casing). In some embodiments, the sensors are incorporated into a fracture sleeve design or casing string.

### EXAMPLES

### Example 1

There are no conducting paths in pure oil. As saltwater is introduced into oil, conducting paths can be formed between two electrodes. With increasing saltwater fraction and its dynamic distribution (e.g., in lab-scale and field-case scenarios), the conducting paths are dynamically formed and broken with the fluid flow from the fractured unconventional reservoir rock.

Point Electrodes vs. Line Electrodes:

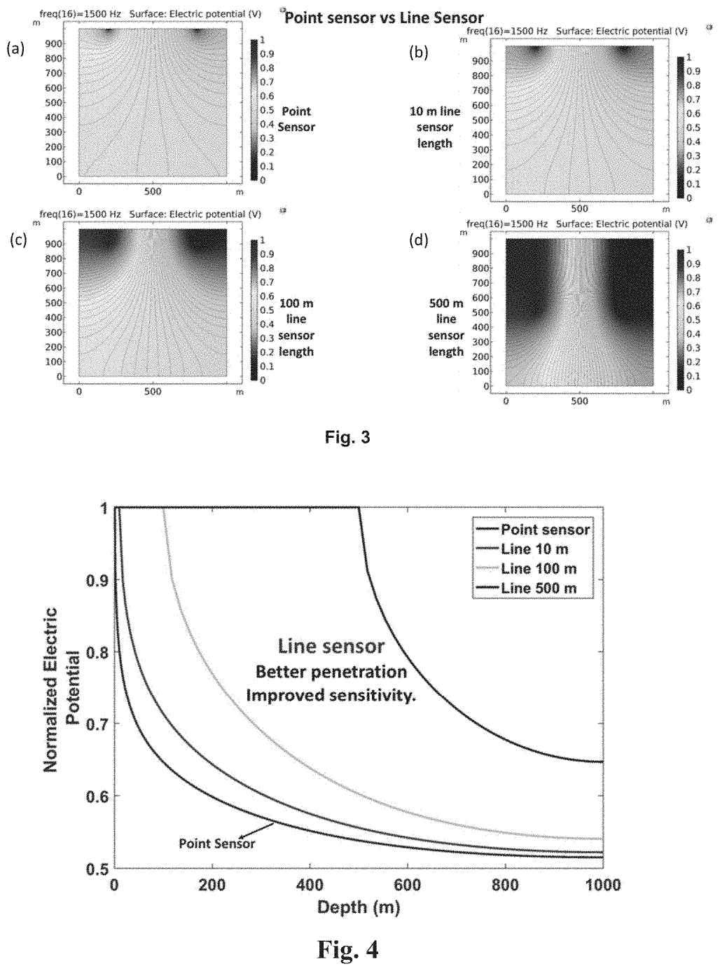

FIG. 3 shows the electrical potential distribution due to point sensors and line sensors at 1.5 kHz. The model domain was a 2D geometry with dimensions of 1000 m×1000 m with two MFEIT sensors. Numerical simulations were performed for different lengths of line sensors (e.g., 10 m, 100 m, 500 m). The line sensors were maintained at a same potential. From this figure, it is evident that the electrical potential distribution for a to point sensor decays faster than line sensors. As the length of the line sensor increases it has greater electrical field penetration. For example, the line sensor with 500 m has greater penetration compared to 10 m and 100 m. FIG. 4 shows a line plot of normalized electric potential as a function of depth at x=0. From this figure it can be concluded that a line sensor (e.g., length of 500 m) has better penetration and improved sensitivity as compared to point sensor.

Characterization Studies:

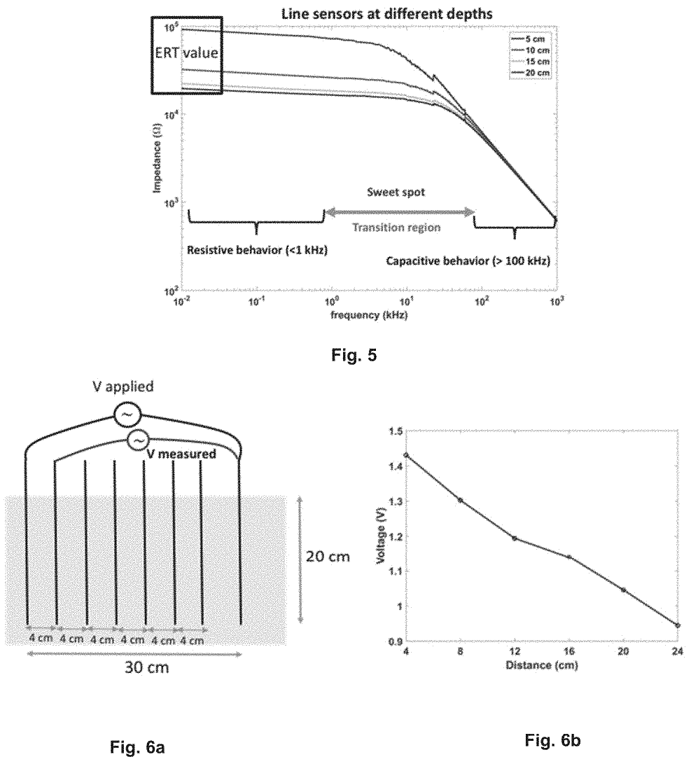

A lab-scale experiment was done to characterize line sensors in sand. The dimensions of the sandbox setup were 40 cm×22 cm×20 cm. Eight-line sensors were equally spaced in the sandbox. Experiments were performed at different line sensor depths to characterize the medium and its frequency dependent properties. FIG. 5 shows the effect of line sensor depth for various depth configurations (e.g., 5 cm, 10 cm, 15 cm, 20 cm). The 5 cm sensor depth scenario effectively corresponds to a point sensor measurement. From this figure, it is clear that the larger the sensor depth, the lower the effective impedance. Lower effective impedance means better coverage and higher data resolution. Based on the experimental measurements (FIG. 5) it is clear that impedance decreases with line sensor depth substantially (e.g., see the plots corresponding to 5 cm and 10 cm depths). Resistive behavior is observed for low frequencies (<1 kHz) and capacitive behavior is observed for high-frequencies (>100 kHz). In the transition region (1 kHz to 100 kHz), impedance is highly sensitive to the frequency of interrogation. As the impedance response is frequency dependent, this transition region is of great interest for probing the subsurface with respect to frequency.

In another experiment, the line sensors were placed at a depth of 20 cm and were equally spaced as shown in FIG. 6a. The distance between the sensors was equal to 4 cm. The voltage was applied at the outer electrodes and was measured between each of the other electrodes and the ground. At lower frequencies, the voltage decayed linearly with distance between the electrodes as shown in FIG. 6b.

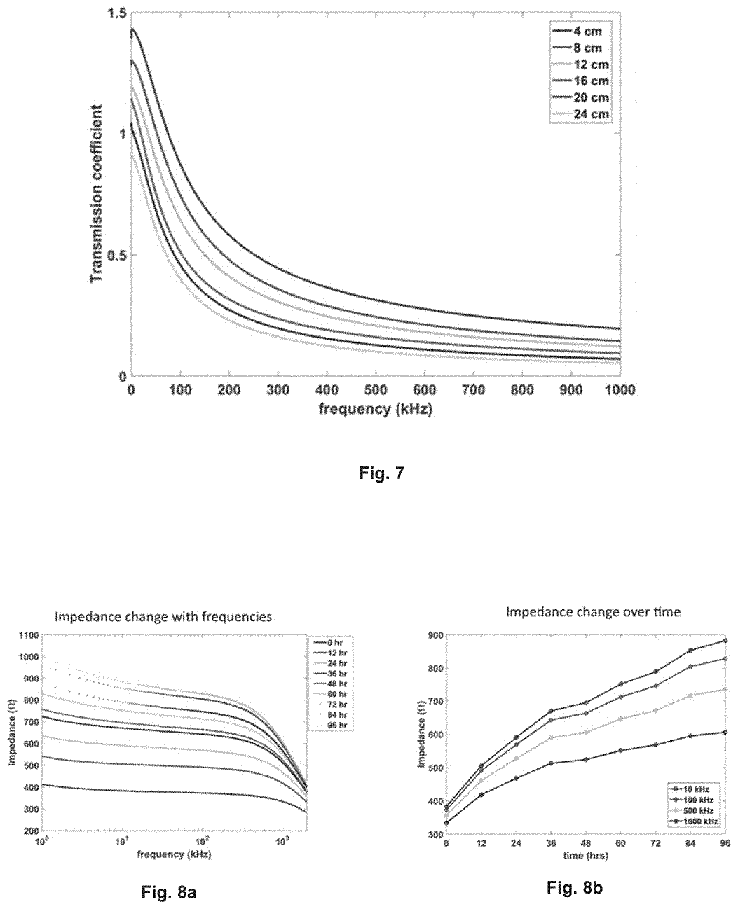

FIG. 7 shows a comprehensive plot of voltage decay with distance for various frequencies. The voltage decayed exponentially with distance over a range of frequencies from 0.1 kHz to 500 kHz. FIG. 8 shows the changes in electrical impedance values with frequencies and time for a three-electrode configuration. Water was slowly introduced into the sandbox over time through a dripper. As the saturation increased, the conductivity of the sand increased over time (FIG. 8a). As a result, impedance value decreased over time for a given frequency over time. The plots also shows the sensitivity of the water saturated sand with frequency (e.g., 10 kHz, 100 kHz, 500 kHz, 1000 kHz) (FIG. 8b).

Thus, the frequency dependent voltage and impedance signals can provide insights on probing subsurface. Additionally, line sensors are effective in characterizing the subsurface due to better penetration of the electrical field and improve sensitivity in characterizing subsurface.

### Example 2

Experimental studies were conducted on a lab-scale flow loop that consisted of a mixer and controller to mix known quantities of mineral oil and water. An oil-water pump was used to flow the mixture through a PVC tube equipped with stainless steel electrodes. Two types of measurement setups were explored: a two-electrode configuration and a four-electrode configuration

Two-Electrode Configuration

The two electrode configuration used two electrodes to measure the frequency-dependent electrical impedance characteristics of the oil-water mixtures. Preliminary tests were carried out to measure the contrast in the electrical properties of water and mineral oil used for the experimental studies.

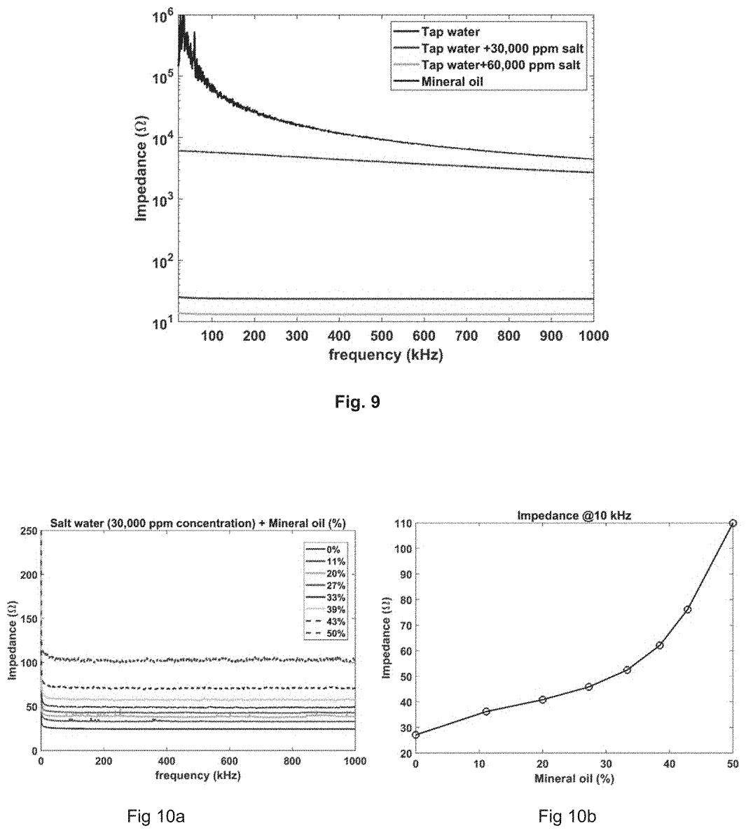

FIG. 9 shows the electrical impedance curves (log-scale on y-axis) for mineral oil and tap water with different salt concentrations (30,000 and 60,000 ppm). There is a significant contrast in the electrical impedance between oil and tap water with salt at all the frequencies measured. Moreover, as the salt concentration increased, the impedance reduced because the mixture becomes more conductive with increasing salt concentration. In addition, the impedance curve tended to get flatter with frequency as the salt concentration increased. This suggests that the mixture tends to be purely resistive in nature as opposed to being capacitive/inductive.

Further experiments were carried out on oil-water mixtures with different mineral oil concentration. FIG. 10(a) shows the electrical impedance curves for different mineral oil concentrations. Beyond a frequency of 1 kHz, all the curves were flat indicating that the mixtures were purely resistive in nature. Shown in FIG. 10(b) is the impedance as a function of mineral oil concentration showing progressive increase in impedance with increasing mineral oil concentration.

Four-Electrode Configuration

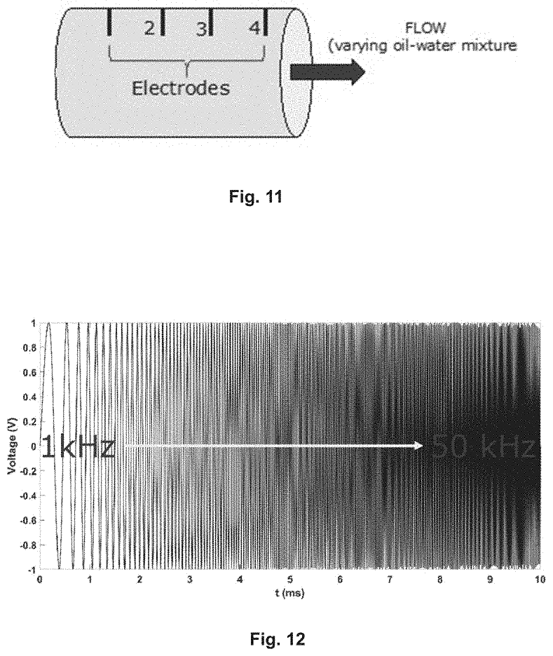

The four-electrode configuration used four electrodes to measure the electrical response characteristics of flowing mixtures. The schematic of the four-electrode configuration is shown in FIG. 11. Two measurement modalities are explored with the four-electrode configuration:

Voltage Input-Voltage Output:

An electrical voltage signal is applied between electrodes 1-4 and the voltage response is measured between electrodes 2-3,

Current Input-Voltage Output:

A current signal is applied between electrodes 1-4 and the voltage response is measured between electrodes 2-3.

The voltage/current signal applied to the electrodes is shown FIG. 12. It was a linear chirp spanning 10 kHz-50 kHz over a 10 milli-second duration. A distinct feature of using such multi-frequency signals is that one can measure the multi-frequency electrical response over a short duration of time. This allows one to characterize any flow dynamics that are not possible with low frequency signals.

The goal of experiments with the four-electrode configuration was to examine the sensitivity of the technique for measurements on oil-water mixtures with a broad range of compositions from pure mineral oil to pure water. The experiments were conducted in two sets. The first set of experiments started with salt water (30,000 ppm) and the composition was gradually varied by adding known quantities of oil until the oil-fraction reached 50% by volume. The second set of experiments started with mineral oil and the salt water was gradually added until the mixture reached 50% water-fraction by volume. Combined results spanned the whole range of volume fractions possible with oil-water mixtures.

Voltage Input—Voltage Output Measurements

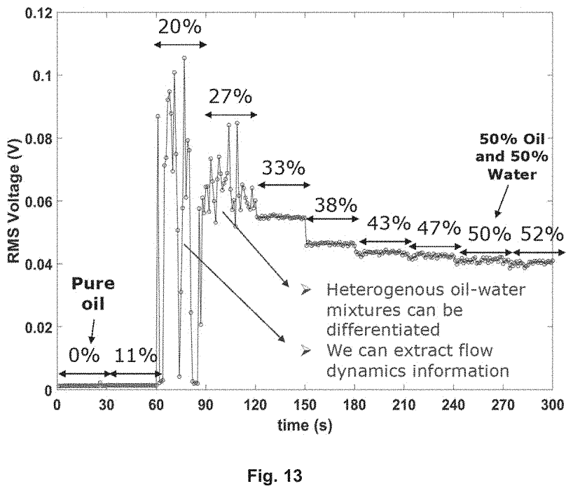

FIG. 13 shows the RMS voltage of the signal obtained from the four-electrode measurement. When the mixture was close to pure oil, there was absolutely no signal received with this measurement mode. This is because there is no conducting path for the current to flow through liquid. With increasing the volume fraction of the salt water, one can see huge fluctuations in the signal received. This is because the salt water establishes conducting paths for the current to flow through the mixture. However, the water concentration was low and hence these conducting paths were formed and broken dynamically resulting in the fluctuation of the signal. On further increasing the volume fraction of salt water, the conducting paths were established and the mixtures conductivity gradually increased. This resulted in a step-like decrease of the voltage signal received that leveled-off at about 50% volume fraction of the mixture. Beyond this, the voltage input-voltage output measurement mode lost sensitivity. This happens because the mixtures become predominantly resistive in nature at a higher volume fraction of salt water. At these volume fractions, the measurement configuration can be considered akin to three resistors in series i.e., one resistor each between electrodes 1-2, 2-3, and 3-4. Hence, the voltage response measured between electrodes 2-3 is about ⅓ of the applied voltage between the electrodes 1-4 and does not appear to change with increasing the volume fraction of the salt-water.

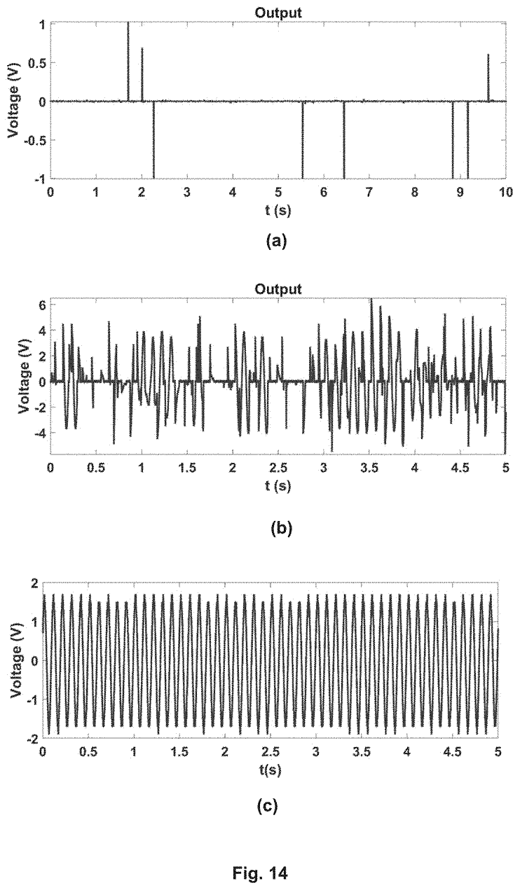

The above set of experiments were performed with a high frequency voltage input i.e., 1 kHz to 50 kHz. A similar set of experiments was performed with a low frequency voltage input i.e., 10 Hz. FIG. 14 shows the signal obtained for different oil-cuts with a 10 Hz continuous sine-wave excitation. When the mixture was close to oil i.e. at high oil-cuts (FIG. 14(a)), there are only few conducting paths that are formed and broken dynamically. This is illustrated by occasional spikes in the received signal. As the oil-cut was reduced, more and more conducting paths were formed and one can see that the signal was present for a larger extent of time (FIG. 14(b)). Upon further reducing the oil-cut, one can see that the signal is present extensively (FIG. 14(c)) indicating that the mixture was completely conducting.

Current Input—Voltage Output Measurements

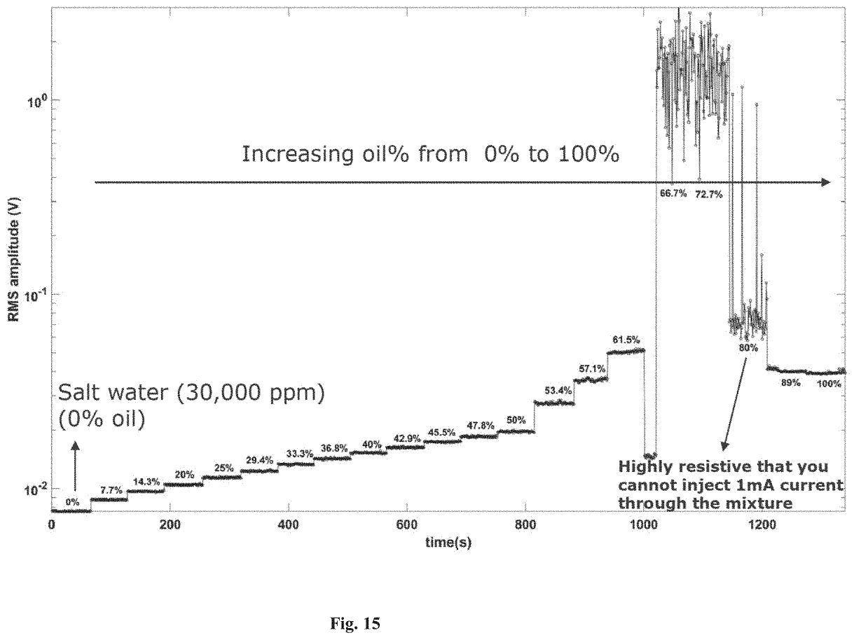

FIG. 15 shows the results obtained for oil-water mixtures with current input-voltage output measurement. A linear chirp signal with amplitude 1 mA was used as the current input between electrodes 1-4 and the voltage output signal was recorded between electrodes 2-3. This approach can quantify the oil-cut until about 70%. Upon further increasing the oil-cut, the mixture becomes highly resistive such that one can no longer inject 1 mA current through the mixture. In other words, the mixture will allow only a small part of the 1 mA current to pass through and the rest is reflected into the electronic equipment injecting the current. However, one can see that this measurement approach has better sensitivity and range compared to the Voltage input Voltage output measurement mode discussed above. While this technique suffers from the drawback that it cannot quantify oil-cut when it is very high, it can identify if the mixture is oil-rich or not.

### Example 3

Integrated Experiments—Numerical Modeling Studies

In this example, numerical modeling studies were performed to compare the results of experiments with those obtained using numerical simulations. First, a stage analysis was performed at zero-frequency by taking the very high conductivity of steel pipe into account. The analysis showed stage impedance is sensitive to inflow fluid conductivity. Second, a numerical simulation was performed to compare experimental and modeling impedance results for different mineral oil-water mixtures at multiple frequencies. The modeling results obtained agree well with the experiments at different frequencies.

Integrated Experiments and Modeling Studies at Single and Multiple Frequencies:

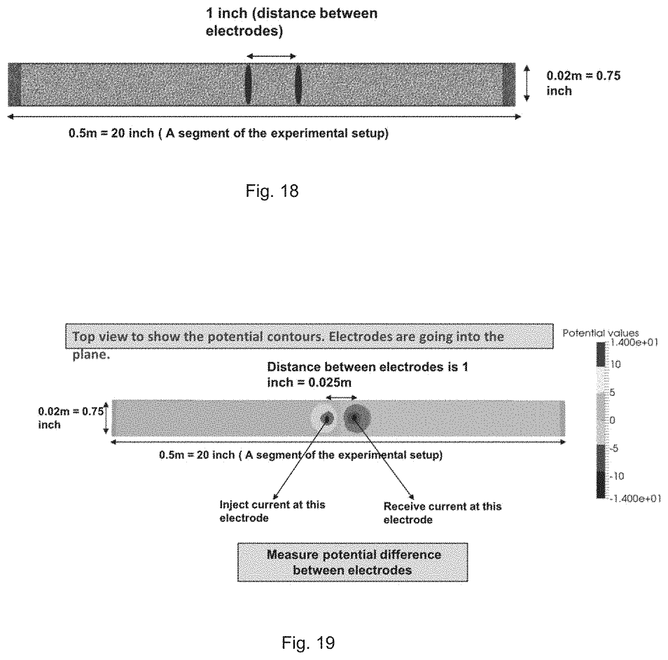

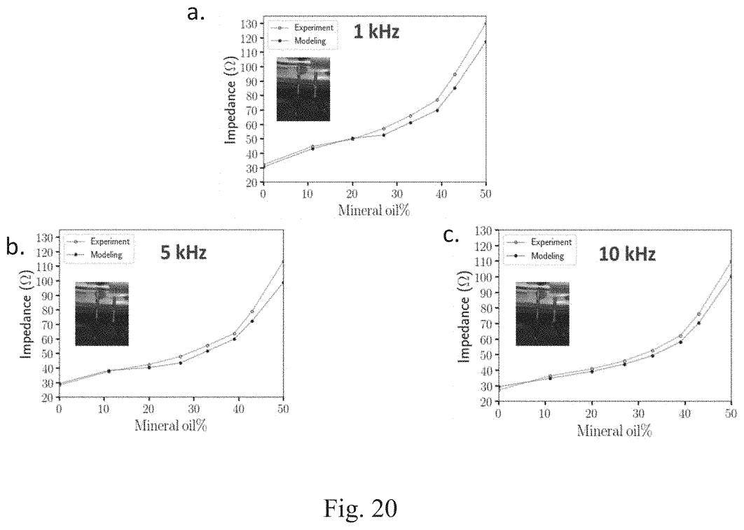

FIG. 18 shows a model domain of an experimental setup. The goal was to compare the experimental and modeling results. The 3D model domain was of length 20 inches. The height and width of the domain was 0.75 inches. The distance between MFEIT electrodes was 1 inch. The fluid conductivities were obtained from prior experiments (Example 1 and 2). These fluid conductivity values were the inputs for the numerical studies. Numerical analysis was performed using both coarse and fine meshes. The coarse mesh consisted of 2.46 million cells and fine mesh consisted of 20 million cells. A current of 1 A was injected at these two electrodes and voltage was measured between them to calculate the impedance. This calculated impedance from numerical results was compared with experimental impedance values at different frequencies of interrogation. FIG. 19 shows the modeling result (potential values) using fine mesh at zero frequency. The modeling contour shows that the value of impedance between electrodes was approximately 29 Ohms and the experimental value for impedance was 27.11 Ohms (e.g., see FIG. 10b). This showed that the measured and simulated values of electrical impedance were close. FIG. 20 compared the experimental and modeling results at frequencies 1. kHz (FIG. 20a), 5 kHz (FIG. 20b), and 10 kHz (FIG. 20c). From these impedance plots, it is clear that modeling results agree well with experiments at multiple frequencies.

### Example 4

Mathematical Models Used in Modeling Studies

E4D was used to model frequency-dependent electrical impedance. E4D is a state-of-the-art, massively parallel code (e.g., uses PETSc) that uses unstructured tetrahedral meshes and low-order finite element method.

General Description of E4D

E4D utilizes finite element meshing tools (e.g, TetGen) to represent the model domain. Also, it uses parallelization (e.g, PETSc, MPI) based on electrode numbers to obtain a cost-effective solution for a given large-scale problem. E4D can model the geometry of the well casing and solve the user-defined problem in an efficient manner. Moreover, E4D can include wells as a highly conductive boundary without explicitly meshing the boundary. E4D can represent well casing using multiple nodes without adding additional mesh cells. This capability is solved in parallel using immersed interface boundary conditions, where the global solution is reconstructed from a series of well-conditioned partial solutions. This capability can simplify the reservoir-scale model development. Also, this feature is useful when an electrode is placed outside of well casing.

Mathematical Equations

The E4D assumes that displacement currents are negligible, and current density can be described by Ohm's constitutive model. The result of the above assumption is a Poisson equation, which determines electrical impedance or electrical potential field by relating induced current to the potential field:

−div[σ(x)grad[Φ_σ(x)]]=Iδ(x−x_0) (1)

where σ [S/m] is the effective electrical conductivity, I [A] the injected current, and Φ_σ(x) [V] the electrical potential all at position-vector x [m] while δ(⋅) is the Dirac delta function.

Equation (1) models the DC effect, which is required in electrical resistivity tomography (ERT) forward modeling; however, it does not account for induced polarization under alternating current (AC). Induced polarization under alternating current results in a secondary potential that needs to be accounted for in the SIP or MFEIT forward/inverse modeling. This requires modification of Equation (1) to solve for the total electrical potential field under IP effects:

−div[(1−η(x))σ(x)grad[Φ_η(x)]]=Iδ(x−x_0) (2)

where Φ_η [V] is the total electrical potential field, which includes IP effects from a polarized material with chargeability distribution η(r) [milliradians]. The secondary potential resulting from the IP effect is:

Φ_s=Φ_η−Φ_σ (3)

and the apparent chargeability is:

η_a=(Φ_η−Φ_σ)/Φ_η (4)

Secondary potential Φ_s and apparent chargeability η_a can be computed by solving Equations (1) and (2). These Φ_η, Φ_σ, and Φ_s are time-domain signatures of induced polarizations. Equation (3) is in the time domain and is transformed into the frequency domain by:

−div[σ\hat{ }*(x,w)grad[Φ\hat{ }*(x)]]=Iδ(x−x_0) (5)

where w [Hz] is the frequency. σ\hat{ }*(x,w) [S/m] and Φ\hat{ }*(x) [V] are the frequency-dependent electrical conductivities and electrical potential, respectively. Φ\hat{ }*(x) is complex potential corresponding to induced polarization that is decomposed into real and complex electrical potentials.

Frequency Dependence

Multi-frequency electrical resistivity modeling or electrical impedance tomography (MFEIT) requires multiple inputs of frequency dependent electrical conductivity. To account for frequency dependence, the Cole-Cole equation is used:

σ\hat{ }*(x,w)=σ_b(x)[1+η_a((iωτ)\hat{ }γ/(1+(1−η_a)(iωτ)\hat{ }γ))] (6)

where σ_b [S/m] is bulk electrical conductivity, i is a complex number such that i\hat{ }2=−1, w [Hz] is frequency, τ is the characteristics relaxation time constant related to characteristic pore or grain size, and γ is a shape parameter (an empirical constant). Equation (6) is used to convert bulk electrical conductivity to complex electrical conductivity. Later, complex electrical conductivity is decomposed into real and imaginary electrical conductivities.

E4D also has the capability of ERT or estimating electrical conductivities by matching electrical impedance. ERT requires a lower number of mesh cells during the electrical conductivity estimation process because it does not require detailed mesh as it is required during forward modeling. Therefore, during the ERT process, a forward modeling run takes shorter time and makes the ERT process faster. The ERT process in E4D is based on minimizing the following objective function to estimate the electrical conductivity distribution, σ_est:

Φ=Φ_d[W_d(Φ_obs−Φ_pred)]+ζΦ_m[W_m(σ_est−σ_ref)] (7)

where Φ_d is an operator that provides a scalar measure of the misfit between observed and simulated data (e.g., electrical impedance) based on the user-specified norm (e.g., Euclidean norm), Φ_m is another operator that provides the scaler measure of the difference between σ_est [S/m] and constraints placed upon the structure of σ_ref [S/m], ζ is the regularization parameter, W_d is the data-weighting matrix, and W_m is the model-weighting matrix. σ_est and σ_ref are estimated and reference electrical conductivities. The ζ value starts as a user-specified value and keeps decreasing as the non-linear iteration progress. Before ζ reduces, the minimum fractional decrease in the objective function, Φ, between iteration has to be less than user-specified value upon which ζ is reduced to a different or similar value. The convergence criteria for the ERT process depends on the χ\hat{ }2 value of the current iteration after data culling and is computed as:

χ\hat{ }2=Φ_d/(η_d−η_c) (8)

where η_d is the total number of survey measurements and η_c is the number of measurements selected from the total number of measurements during the current iteration.

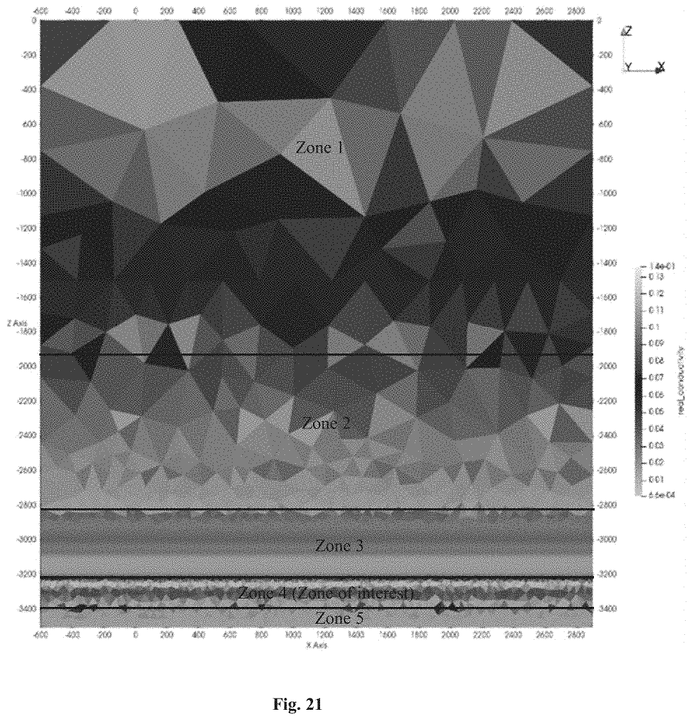

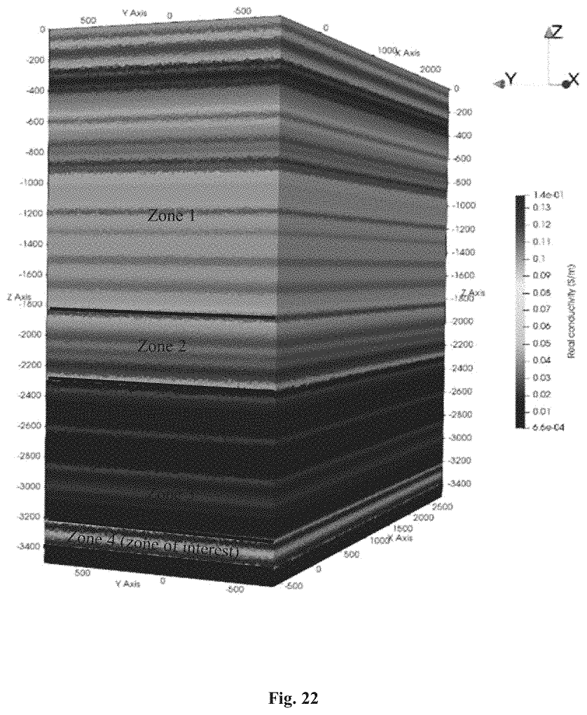

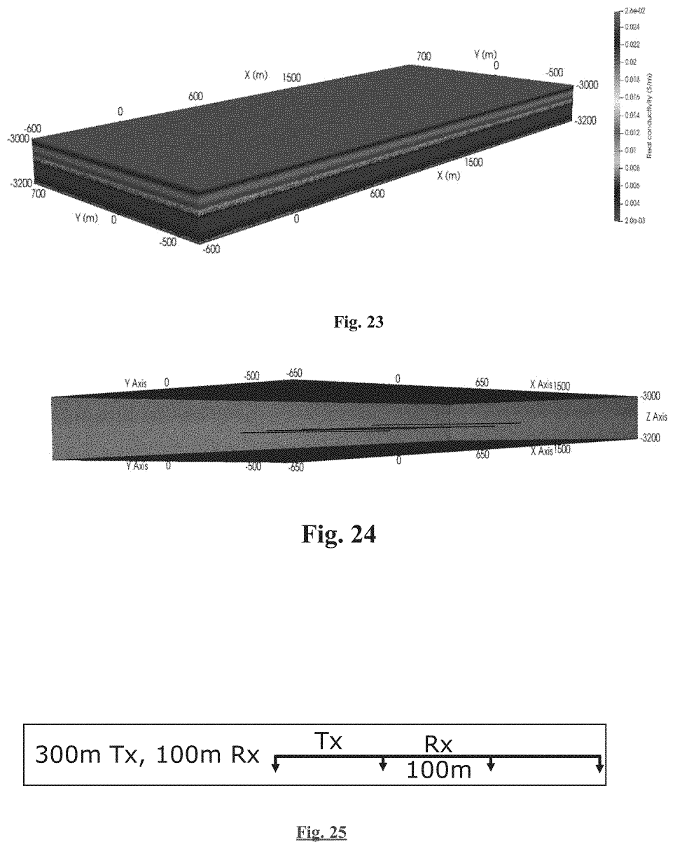

A model with dimensions of 3,500×1,500×3,500 m³ (see, FIG. 21 and FIG. 22) was built from a prior reservoir model. FIG. 21 is a coarse-scale model, which has ˜3.2 million finite element cells. FIG. 22 is a finer-scale model, which has ˜6.4 million finite element cells. Both models include six wells (see FIG. 24), which were treated like infinite conductive boundary. In X-coordinate, wells extend from 200 m to 2,700 m, and each well was 50 m from the other wells. The model domain was subdivided into a total of five zones, and maximum mesh cell size is found in Table 1. In the zone of interest, where hydraulic fracturing happens (see, FIG. 23), mesh is finer than top zone and below the zone of interest.

TABLE 1
Mesh size for different zones

| | Maximum coarser | Finer mesh |
|---|---|---|
| Zone number | mesh size (m³) | size (m³) |
| 1 | 1 × 10¹² | 1 × 10¹² |
| 2 | 1 × 10⁸ | 1 × 10⁴ |
| 3 | 1 × 10⁷ | 1 × 10⁴ |
| 4 | 1 × 10³ | 1 × 10³ |
| 5 | 1 × 10⁵ | 1 × 10⁴ |

Field-Scale Computational Model Setup

Electrical conductivities (reciprocal of electrical resistivity) were imported from a prior model into the reservoir model. Four electrodes were placed within well-2 that model the electrical impedance due to the response by layered electrical conductivities in the model domain. The Wenner electrical configuration was used, as shown in FIG. 25. The total distance between the first and fourth electrodes was 300 m, and each electrode was separated by 100 m. The first and the fourth electrodes were used as source and sink electrodes, respectively. The second and third electrodes were used as potential/impedance measurement electrodes. E4D enforces zero potential on boundaries of the domain to solve Equation (5). During forward modeling, electrical conductivities were kept constant. Real and imaginary electrical conductivities varied according to the Cole-Cole model, which accounted for frequency dependency of electrical conductivity. Equation (6) was used to convert given layered-bulk electrical conductivities into real and imaginary electrical conductivities for 1, 10, 100, and 1,000 Hz.

Results and Analysis

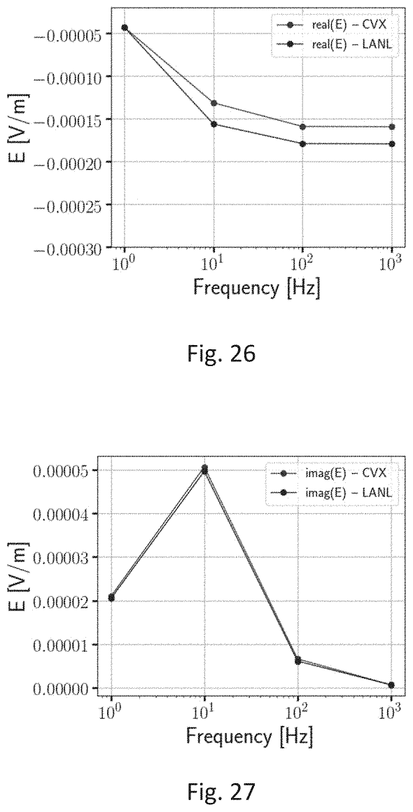

With the preceding model domain and electrode configuration, the model was run using five processors (Intel® Xeon® CPU E5-2695 v4 \@ 2.10 GHz) for four frequencies (1, 10, 100, 1,000 Hz). Among five processors, one was used as the parent, and four were used as child processors. For each frequency, the coarse model converged after about 8 minutes and the finer model took about an hour. During the forward modeling, 1 A current was injected into source electrodes. The injected current flowed from source to sink electrode. During this flow, potential value dropped from one electrode to another electrode. The second and third electrodes measured the drop of potential value, which is electrical impedance. The model provides complex electrical impedance of the whole model domain. The complex electrical impedance was decomposed into real and imaginary impedances. Later, electrical impedances were converted to electrical fields using E=∇Φ where ∇Φ=ΔΦ/Δl. Electrical fields were plotted, which were generated by the finer model because it provided better results than the coarse model. Both components of electrical field for four frequencies were plotted in FIG. 26 and FIG. 27. FIG. 26 and FIG. 27 also show the electrical fields for four frequencies from a prior simulation with a different code and model. Electrical fields from these reservoir-scale models agreed well with the prior reservoir model with negligible discrepancy in both real and complex components.

### Example 5

Field-Scale Electrode Placement Studies

Based on the above examples, studies were carried to find optimal electrode placement. This example describes the details of the placement approaches used with the field-scale model.

Detailed Designs of Electrode Placement Based on Scoping and Modeling Studies:

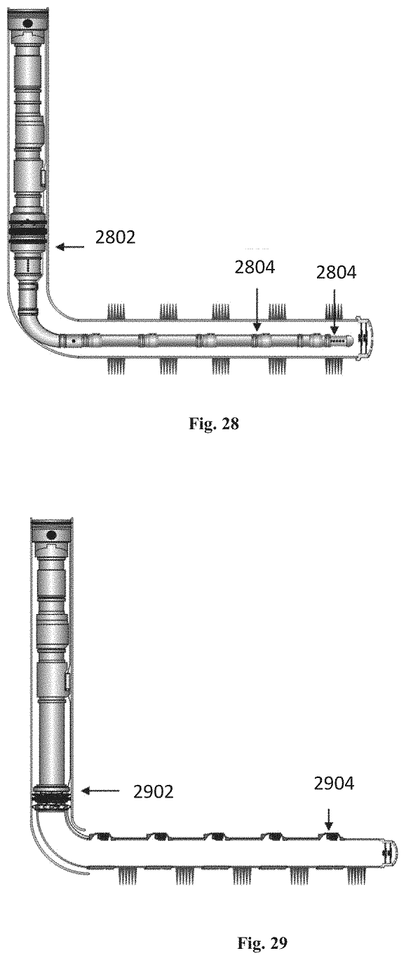

There are various operational challenges (e.g., corrosive conditions) associated with electrode/sensor placement inside or outside of well casing. FIG. 28 and FIG. 29 are two different types of electrode placement designs (one inside the well and other outside the well). Other placement strategies could also be used, such as placement within a sleeve. A first embodiment is inside the casing as shown in FIG. 28. The horizontal well comprises a perforation pup 2802, multiple EIT subs 2804, and a perforated sleeve 2806. A second embodiment is on a tailpipe below the packer as shown in FIG. 29. The horizontal well comprises a feed-through liner-hanger/packer 2902 and multiple EIT subs 2904. A summary of the designs is described in Table 2.

TABLE 2
Embodiments of two sensor placement designs

| Outside of casing | On tailpipe below packer |
|---|---|
| 5″ casing (TBC) | 5.5″ or 5″ casing |
| Feedthru liner hanger | Feedthru hydraulic packer |
| 2-⅞″ Production tubing | Hybrid (fiber & electric) or electric |
| Side-pocket mandrels or special build | control line (shown in red) |
| subs. Offers possibility of memory | 2-⅞″ or 2-⅜″ stinger tubing |
| module/battery pack and/or inductive | Electrical connections each EIT sub |
| wireless interrogation or turbine | Optional perforated joints/sleeves |
| install (low TDS) | for deployment and flow |
| Hybrid or electric control line (not | |
| required if used in memory mode) | |
| (shown in red) | |
| Oriented perforation (not required if | |
| used in memory mode) | |

### Example 6

Stage Analysis for Zero-Frequency Based on the Experimental Data:

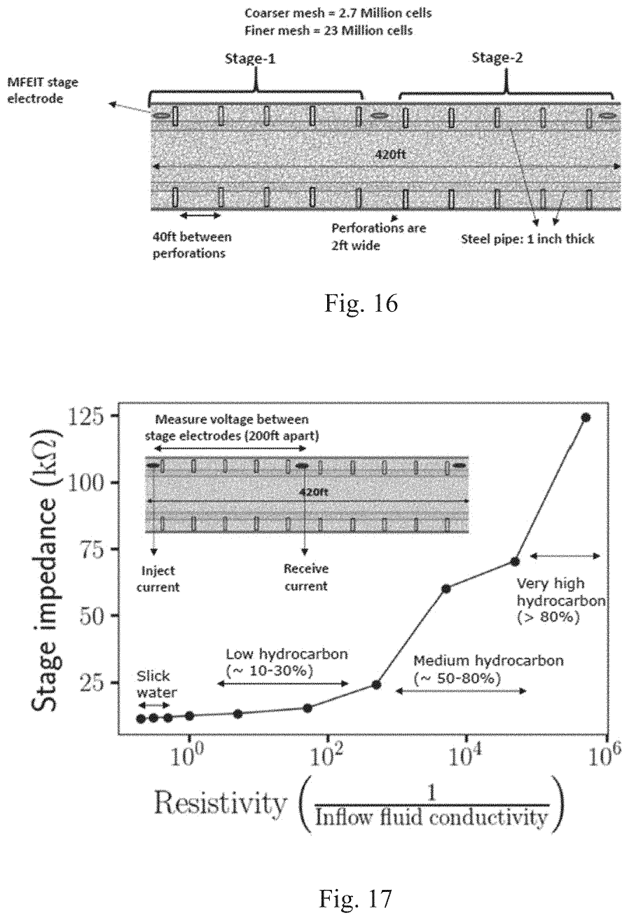

FIG. 16 shows a mesh model of a hydrocarbon producing stage. The 3D model domain was 420 ft in length and 9 inches in height and width. The steel pipe was 1 inch thick. The region enclosed between the pipe was 3 inches. The region above the pipe was 2 inches. The model domain consisted of two stages with each stage having a length of 180 ft. The stage background conductivity was set to 0.02 S/m and the distance between stage MFEIT electrodes was set to 200 ft. Each stage consisted of 5 perforations which were uniformly space. The distance between each perforation was 40 ft. The perforations were 2 ft. wide. Each stage contained 2 MFEIT electrodes. In the numerical simulations, the inflow fluid conductivies were allowed to vary. These inflow fluid conductivities were obtained from experiment as determined from Examples 1 and 2. The output of the numerical simulations was voltage of the entire domain. This simulation output also included voltage at each of the electrodes. Current was injected at one electrode and it was received at another electrode (which were 200 ft. apart for this simulation). Voltage was measured between these two electrodes (current injecting electrode and current receiving electrode). Voltage difference divided by current provided stage impedance (which is an average quantity per stage). Numerical simulations were performed at low frequency, which was at 10 Hz in this example. Fluid conductivity values at this frequency were taken from experiments (see Examples 1 and 2). Fluid conductivity within the cluster was not varied in this example. That is, the heterogeneity of the fluid conductivity within the cluster was not considered in these numerical simulations. The distance between electrodes was kept constant. Numerical analysis was performed using coarse mesh and fine mesh. Coarse mesh consisted of 2.7 million cells and fine mesh consisted of 23 million cells. Each simulation run was performed by varying the fluid conductivity in the cluster. For example, a simulation run was performed by assuming clusters had slick water (3.25 S/m). Another simulation run was performed by assuming the clusters had 90% hydrocarbon (10⁻⁶ S/m).

FIG. 17 shows the results of simulations, which were stage impedance vs. inflow fluid conductivity at 10 Hz. As a feasibility demonstration, a total of 10 high-resolution simulations (e.g., fine mesh of size 23 million cells) were performed by assuming varying fluid conductivities to calculate the stage impedance. Cluster fluid compositions were varied, which spanned from slick water to pure hydrocarbon since real-life scenarios can have highly heterogenous systems. That is, background conductivity was fixed but clusters were producing fluids whose conductivities are changing drastically (3.25 S/m to 10⁻⁶ S/m). Slick water (3.25 S/m) was highly conductive compared to background conductivity (0.02 S/m). Pure hydrocarbon (10⁻⁶ S/m) was highly resistive compared to background conductivity (0.02 S/m). As the system was highly heterogenous (background+different clusters producing different fluids), multiple realizations accounting for different producing scenarios were performed in this example.

To calculate stage impedance, a current of 0.1 mA was injected into the simulation and the corresponding voltage at the electrodes and in the entire domain (which is on the order of Volts) was then measured. The voltage difference measured at electrodes divided by current induced gave the stage impedance (on the order of kiloohms), which represents the average impedance of the stage. For pure hydrocarbon, modeling results show that the stage impedance was approximately 125×10³ Ohms when clusters were producing hydrocarbon. If the clusters were producing slick water the corresponding stage impedance was approximately 25×10³ Ohms. The impedance difference between a stage that was producing hydrocarbon and a stage that was producing slick water was about 100×10³ Ohms. This change can be captured even under noisy conditions. To summarize, these numerical modeling studies show that the stage impedance varies greatly with different fluid compositions and the use of a single electrode per stage can be sufficient to identify the production in the stage under conditions assumed in the simulation.

Simulation of Potential Sensor Placement

The model from above with respect to FIGS. 16 and 17 was used to simulate a variety of different distances between the sensors. The distances simulated between sensors were 180, 200, 225, 250, 275, and 300 feet. These distances represent example scenarios that are economically feasible. For example, such distances (e.g., 200 ft) include an electrode being placed at each stage.

The input of the simulation included within the 3D model: domain size, length of the well, placement of perforation spacing, height of the well, amount of perforations, steel infrastructure dimensions, length of perforations, distance between perforations, distance between stages, and size of perforations. Some of these inputs were part of a 3D model that was used with respect to FIGS. 21-27. Multiple 3D models of FIGS. 16-17 with different spacing between sensors were run in the simulation. Other inputs included steel infrastructure including steel conductivity, background conductivity, fluid conductivity, injected current, amount of mesh refinement in each area within the model (higher inside, lower outside), number of processors, selection of output measurement. Variables between the different 3D models and simulations included sensor location, distance between sensors, source electrode, receiver electrode, and number of electrodes. Use of other variables is contemplated. E4D was used to simulate the model and to compute the given conductivity and voltage. The simulation output the potential difference between two electrodes.

Results: The distances of 180 feet between sensors and 200 feet between sensors had similar results and demonstrated the best sensitivity for all of the sensor placements calculated. As such, 200 feet was chosen as the optimal distance as fewer sensors were needed to achieve a similar sensitivity.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A method for determining placement of MFEIT sensors in a subterranean reservoir comprising:
receiving, at a computer, a fluid conductivity, a background conductivity, a current to be injected, and a geological model of the subsurface reservoir, wherein the geological model comprises a domain size, a plurality of sensor locations, steel infrastructure dimensions, a horizontal well location, steel infrastructure locations, a distance between perforations, and a distance between stages;
simulating an injection of the current at a first sensor location using the geological model and the background conductivity;
calculating a voltage received at a second sensor location;
outputting the voltage.

2. The method of claim 1, further comprising receiving the first sensor location where the current is injected, and the second sensor location where the voltage is received.

3. The method of claim 1, further comprising placing sensors in the subterranean reservoir at the plurality of sensor locations.

4. The method of claim 1, further comprising:
receiving a second plurality of sensor locations;
simulating a second current injected at a first sensor location of the second plurality of sensor locations;
calculating a second voltage received at a second sensor location of the second plurality of sensor locations;
comparing the voltage received at the second sensor location and the second voltage received at the second sensor location of the second plurality of sensor locations; and
outputting a highest voltage as between the voltage received at the second sensor location and the second voltage received at the second sensor location of the second plurality of sensor locations.

5. The method of claim 4, further comprising outputting sensor locations associated with the highest voltage.

6. The method of claim 5, further comprising placing sensors in the subterranean reservoir at the sensor locations associated with the highest voltage.

7. The method of claim 1, wherein:
simulating the injection of the current at the first sensor location includes simulating the current being injected at a first electrode and the current being received at a second electrode; and
calculating the voltage received at the second sensor location includes measuring simulated voltage between a third electrode and a fourth electrode, wherein the third electrode and the fourth electrode are between the first electrode and the second electrode.

8. The method of claim 1, wherein the plurality of sensor locations are outside the horizontal well location.

9. The method of claim 1, wherein the plurality of sensor location are within the horizontal well location.

10. The method of claim 1, wherein the subterranean reservoir is an unconventional formation.

11. A non-transitory computer readable medium comprising computer executable instructions that, when executed on a computer, cause the computer to perform steps comprising:
receiving, at a computer, a fluid conductivity, a background conductivity, a current to be injected, and a geological model of the subsurface reservoir, wherein the geological model comprises a domain size, a plurality of sensor locations, steel infrastructure dimensions, a horizontal well location, steel infrastructure locations, a distance between perforations, and a distance between stages;
simulating an injection of the current at a first sensor location using the geological model and the background conductivity;
calculating a voltage received at a second sensor location;
outputting the voltage.

12. The computer readable medium of claim 11, further comprising receiving the first sensor location where the current is injected, and the second sensor location where the voltage is received.

13. The computer readable medium of claim 11, further comprising placing sensors in the subterranean reservoir at the plurality of sensor locations.

14. The computer readable medium of claim 11, further comprising:
receiving a second plurality of sensor locations;
simulating a second current injected at a first sensor location of the second plurality of sensor locations;
calculating a second voltage received at a second sensor location of the second plurality of sensor locations;
comparing the voltage received at the second sensor location and the second voltage received at the second sensor location of the second plurality of sensor locations; and
outputting a highest voltage as between the voltage received at the second sensor location and the second voltage received at the second sensor location of the second plurality of sensor locations.

15. The computer readable medium of claim 14, further comprising outputting sensor locations associated with the highest voltage.

16. The computer readable medium of claim 15, further comprising placing sensors in the subterranean reservoir at the sensor locations associated with the highest voltage.

17. The computer readable medium of claim 11, wherein:
simulating the injection of the current at the first sensor location includes simulating the current being injected at a first electrode and the current being received at a second electrode; and
calculating the voltage received at the second sensor location includes measuring simulated voltage between a third electrode and a fourth electrode, wherein the third electrode and the fourth electrode are between the first electrode and the second electrode.

18. The computer readable medium of claim 11, wherein the plurality of sensor locations are outside the horizontal well location.

19. The computer readable medium of claim 11, wherein the plurality of sensor location are within the horizontal well location.

20. The computer readable medium of claim 11, wherein the subterranean reservoir is an unconventional formation.
